(19) United States
(12) Patent Application Publication
(10) Pub. No.: US 2012/0005037 A1
(43) Pub. Date: Jan. 5, 2012

(54) Kiosk system, providing anonymous purchases of legal, adult, sexually-orientated products from internet websites

(76) Inventor: Anthony Willis Dodge, Hammond, LA (US)

(21) Appl. No.: 12/800,488

(22) Filed: May 17, 2010

(51) Int. Cl. G06Q 30/00

(52) U.S. Cl. 705/26.8

(57) ABSTRACT

The invention relates to the purchasing of legal, adult, sexually-orientated materials by an end customer from a specific (or multiple designated) internet website(s). This invention relates specifically to the selection of materials to be purchased by an end customer, the transfer of funds from the end customer to the website owner(s) through the use of a third-party agent, herein after referred to as the retail establishment, the transfer of the purchased materials from the website owner to the end customer via the retail establishment, and the receipt of proceeds by the retail establishment from the website operator(s) that constitute gross profits (calculated as cost of item(s) (including applicable shipping costs) from the website operator(s) subtracted from retail prices charged to the end customer, or in lieu of gross profits, a commission payable to the retail establishment calculated in the same manner as gross profits.

### BACKGROUND OF THE INVENTION

Many end customers have the desire to purchase legal, adult, sexually-orientated materials from an internet website, but are concerned about privacy issues as they relate to the transfer of funds for the purchase and the shipment of the items purchased to a customers home, office or other location. This invention creates a business practice that eliminates the need for the customer to provide personal financial information and provides a location to where the purchases can be shipped to for pick up by the customer.

Legal, adult, sexually-orientated materials are any material or media that describes, depicts or displays sexual content or acts either individually or with 2 or more people, commonly referred to as (but not limited to) adult, x-rated DVDs or videos, magazines, and books; sexual pleasure enhancement devices commonly referred to as (but not limited to) dildos, vibrators, dongs, massagers, masturbators, and other common references.

With this business practice, the end customer may enter a designated retail establishment, use a system (proposed to be configured as a kiosk, but not limited to that style of configuration) that consists of a monitor, computer, pointing device (mouse, touch-screen or other pointing device), character entry device (physical or monitor-screen based virtual keyboard), receipt printer and internet connectivity. This system will connect to a specific (or multiple designated) internet website(s) that sells legal, adult sexually-orientated materials. The customer will be able to navigate through the website to view pictures, prices and descriptions of the materials, and make a decision whether to purchase an item.

If the end customer decides to purchase an item or items, it/they are placed into an electronic shopping cart on the website. When the end customer is finished shopping, they will review the entire contents of their shopping cart and the purchase total of the materials contained in the cart. The website application will calculate shipping costs for delivery to the retail establishment where the kiosk system is located, and add those costs to the financial transaction total. The end customer will then approve the purchase, at which time the website application will assign a discrete transaction number to the purchase, and print a receipt from the printer within the kiosk system.

The end customer will then take the printed receipt to the cashier at the retail location and make payment to the cashier upon agreed terms. The end customer will have the option of making the payment in the form of cash or other non-private methods of payment, thereby eliminating the need to provide personal financial information. Thus this business method provides the customer with anonymity when making a purchase of legal, adult sexually-orientated materials via the internet.

### DETAILED DESCRIPTION/SPECIFICATION

The inventor requests a patent on the business method of providing an anonymous means of purchasing legal, adult sexually-orientated materials to an end customer purchasing said materials from a designated (or multiple designated) website(s) without requiring the customer to provide personal financial details, generally defined in the form of personal credit card information either directly from the customer or via a third-party payment application, using Pay-pal or Western Union funds transfer services as examples of these types of third-party applications. The end customer will have the ability to place the order from a kiosk system that will access a designated (or multiple designated) website(s), and pay for any purchase at the retail establishment where the kiosk is located, using cash or other approved methods of payment. The purchased materials will then be shipped to the retail establishment that accepted the payment, where the materials will be held for end customer pickup. If the end customer requests, the alternative option will always be available for the customer to provide specific, personal financial information no differently than on other websites. While that option is currently a world-wide accepted business method, this is noted only to differentiate from the original option of providing an anonymous purchase experience, which is the business method the inventor is requesting a patent for.

This business method requires the following:
1. The inventor develops a kiosk system that consists of a computer, a monitor, a printer, a keyboard (either physical or virtual), a pointing device (a mouse or monitor touch-screen system), a network communication firewall-router, electrical and internet connections.
2. The inventor enters into an agreement (or agreements) with website operators to allow their website(s) to be accessed from the kiosk system. No unauthorized websites will be allowed to be accessed from the kiosk system.
3. The website operator(s), also referred to as a distributor, will enter into either a wholesale agreement or a commissioned sale agreement with the retail establishment. If the option is a wholesale agreement, when materials are shipped to the retail establishment for end customer pickup, title/ownership of the materials pass from the distributor to the retail establishment, then to the end customer. If the option is a commissioned agreement, the title of the materials are retained by the distributor until the end customer picks up and makes final payment for the materials, at which point title transfers to the end customer. In the commissioned agreement, the retail establishment never retains title to the materials, but only acts as a payment agency and delivery pickup point.
4. The retail establishment will provide space within their physical business establishment for placement of the kiosk system. This kiosk system will be placed on top of a sales counter, affixed to a wall or other vertical facing, or placed on a floor stand. The retail establishment will also provide an electrical connection and a broadband, high-speed Internet connection.
5. As part of the agreement, the website operator(s) will provide functionality on their website in adherence to the operation of the kiosk system, including (but not limited to) a retail pricing matrix controlled by the retail establishment, the website appearance to be that of the retail establishment if requested rather than the website operator, the programming to allow for a website visitor to review and possibly place an order for an item or items, the programming to print a receipt at the kiosk system that represents the end customers order, the programming that will require the retail establishment to acknowledge and approve the order prior to being processed, and any other programming required for efficient operation of the business method.
6. The transaction process is as follows: the end customer enters the retail establishment; the end customer accesses the kiosk system and purchases items from the website(s) accessed by the kiosk system; the kiosk system prints a receipt which the end customer takes to the cashier in the retail establishment; the cashier collects initial payment in agreed-upon terms from the end customer (typical (though not limited to) terms would be 50% of the sale total at the time of order placement, and the balance of 50% of the sale at the time of order pickup by the end customer); upon receipt of the initial payment, the retail establishment approves the order with the website operator(s); the website operator(s) prepare and ship the order to the retail establishment; the end customer returns to the retail establishment, pays any remaining balance due and receives the order.
7. Non-private methods of payment are used by the end customer for payment of the order to the retail establishment. Non-private methods of payment include (but are not limited to) cash/currency, store-issued gift cards, card-company (Visa, Master Card, etc.) gift or purchase cards not specifically assigned to an individual.
8. If an end customer does not require an anonymous transaction, that customer may opt to use a private method of payment, including (but not limited to) personal or company credit cards, personal or company debit/check cards, personal or company checks drawn on a bank. End customers using private methods of payment are not covered in this business method, but are listed for the purposes of clarity on the requested patent of the original business method.
1. Inventor/kiosk system supplier enters into agreement with Distributor/website operator that will allow the website to appear and transactions on that website to be executed by the kiosk system.
2. Distributor/Website operator develops website that allows for approved functionality with Kiosk system.
3. Inventor/Kiosk system supplier sells Kiosk system to Retail Establishment and enters into operating agreement with Establishment.
4. Distributor/Website operator enters into agreement authorizing Retail Establishment as reseller or independent commissioned agent.
5. Retail Establishment places Kiosk system in store, provides electrical and internet connectivity and consumable supplies.
6. Inventor/Kiosk system supplier programs system to allow for connectivity to Distributor website, allowing full interface between system and website.
7. End Customer accesses website using Kiosk System, browses materials, chooses items for purchase.
8. Kiosk system prints receipt representing End Customer's purchased items.
9. End Customer pays Retail Establishment according to terms using non-private, anonymous payment type if desired.
10. Retail Establishment logs into website and acknowledges payment for End Customer's order, which approves order for processing and shipping.
11. Distributor ships End Customer's order to retail Establishment, charges Retail Establishment wholesale price of items ordered, or charges retail price of items ordered less commission due to Retail Establishment.
12. End Customer returns to Retail Establishment, pays any remaining balance due, and receives ordered items.

What is claimed is:

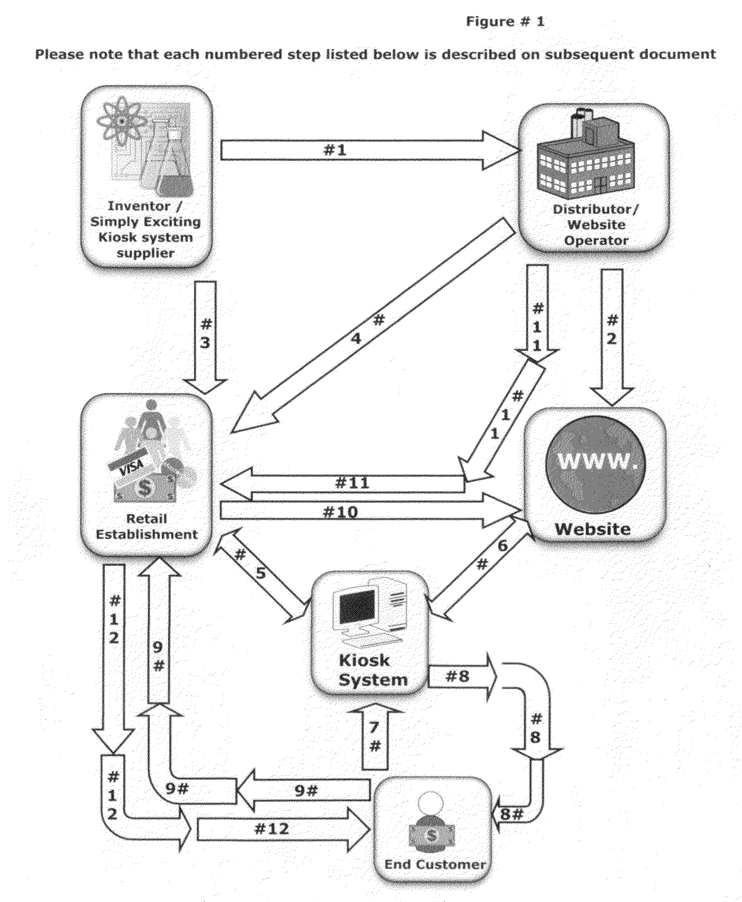

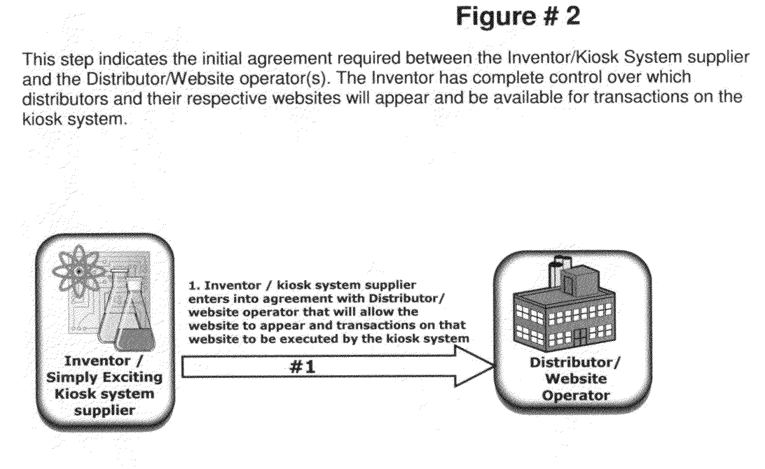

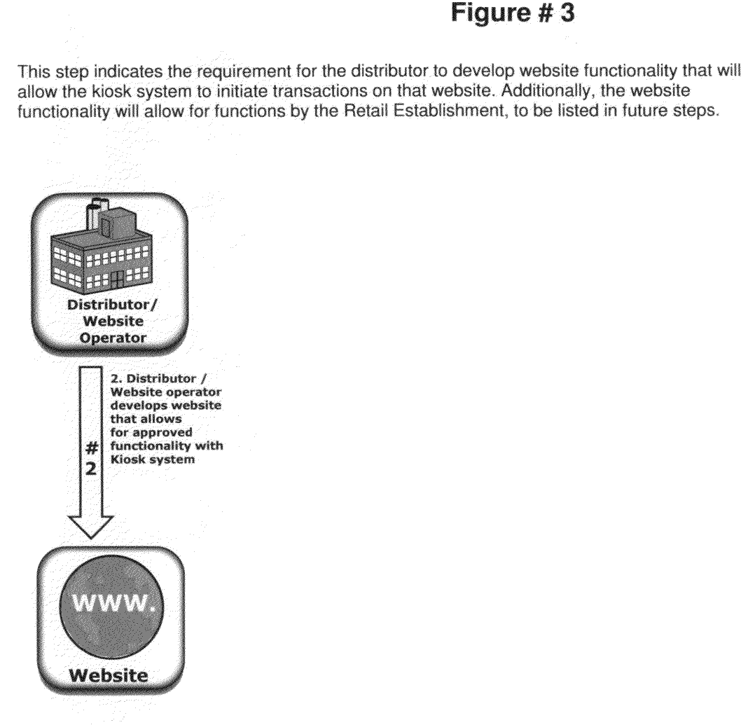

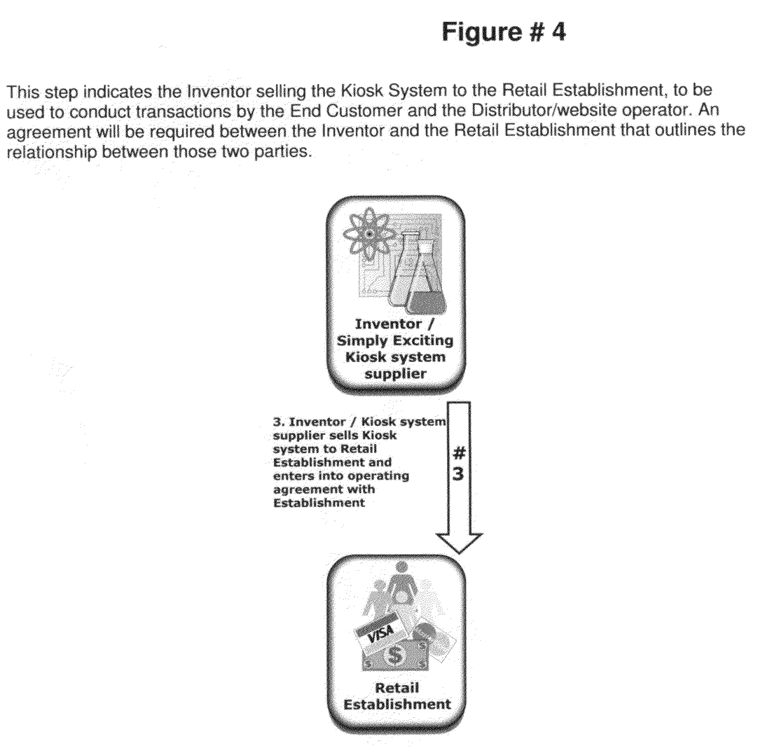

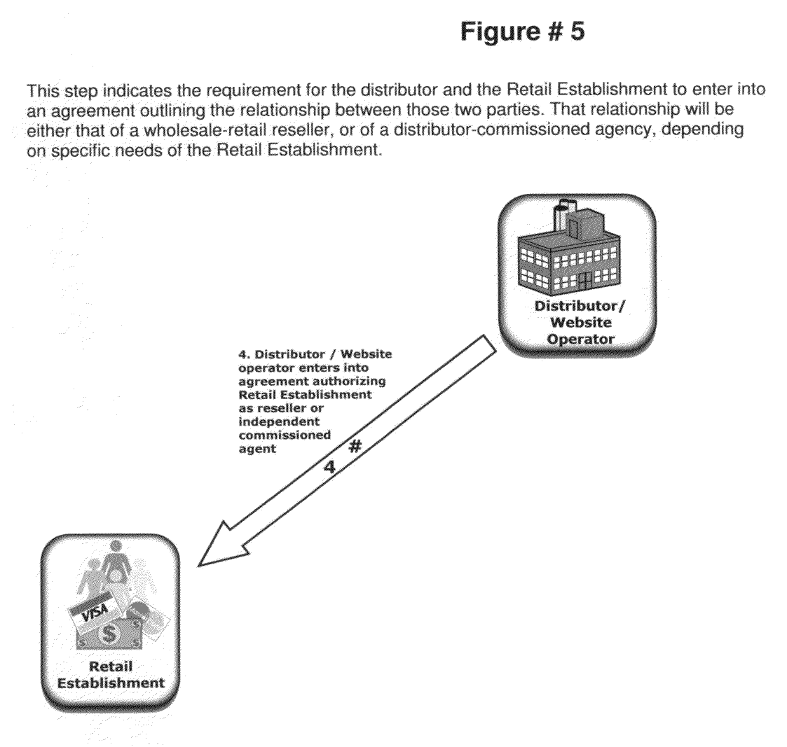

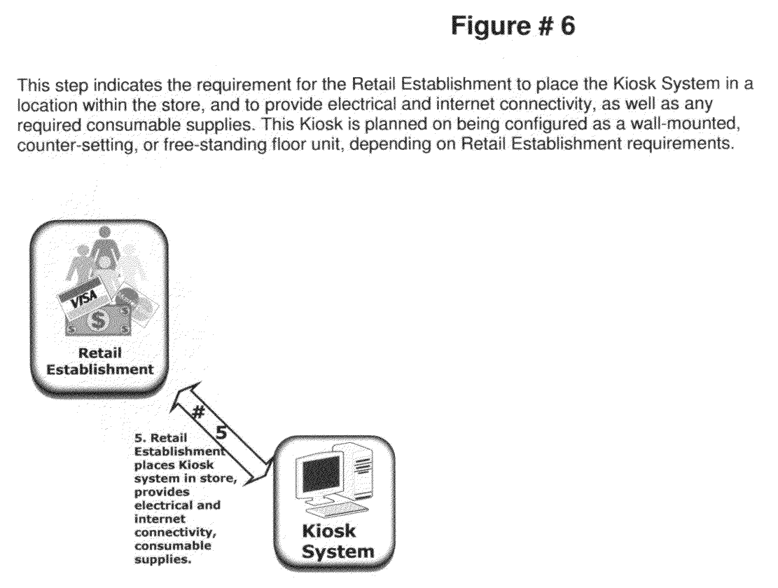

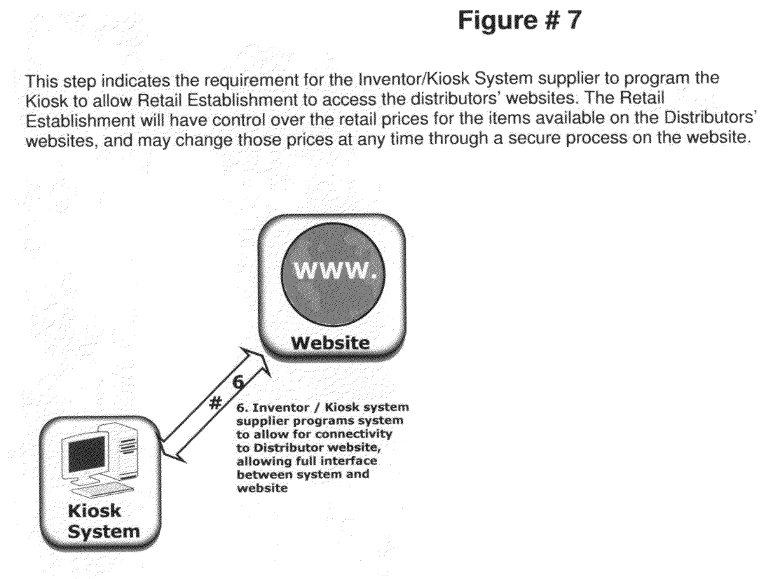

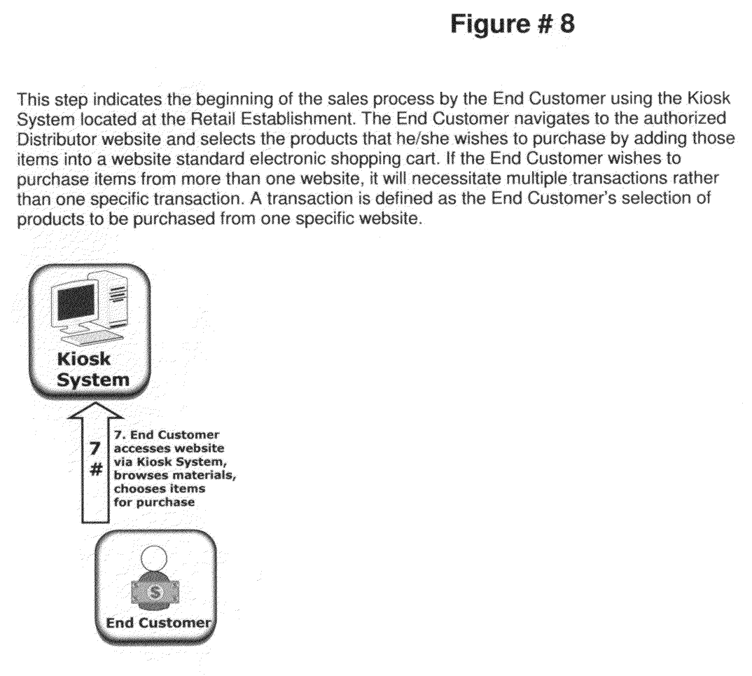

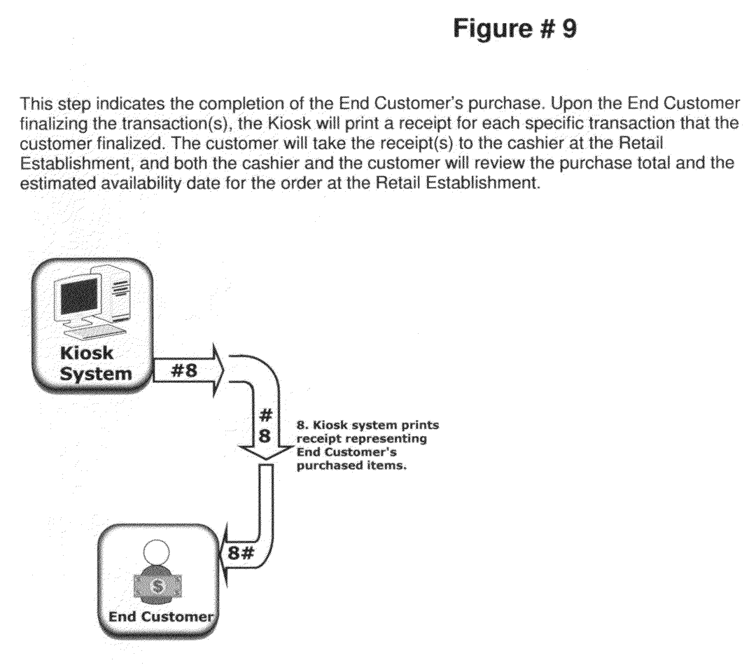

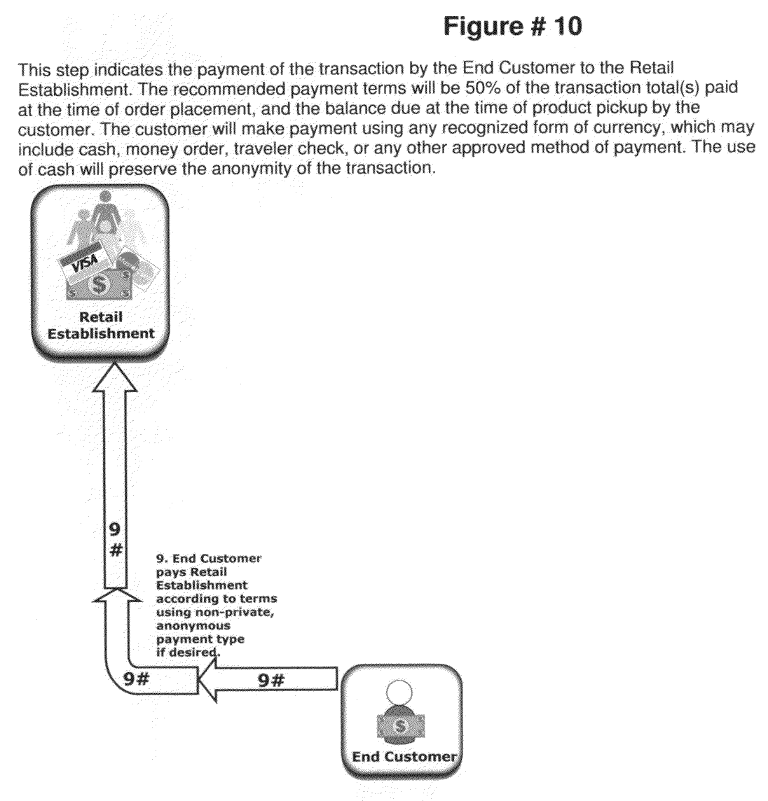

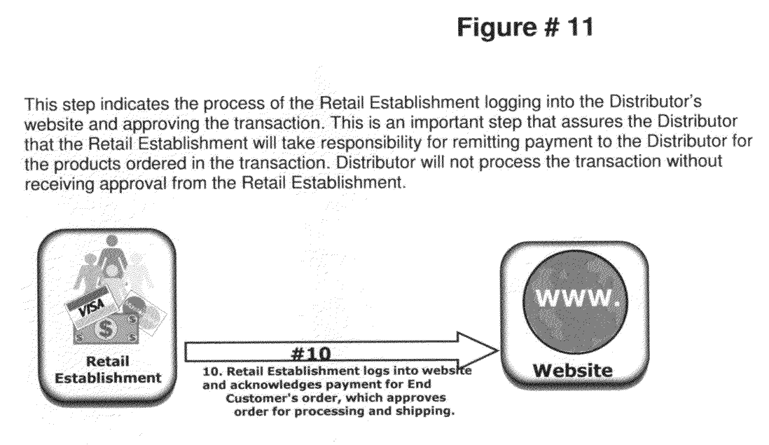

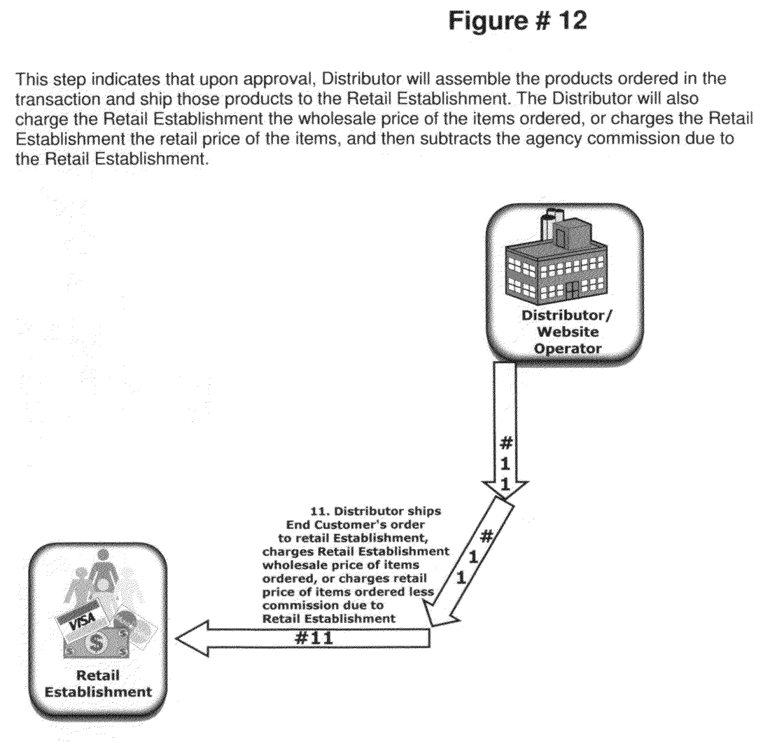

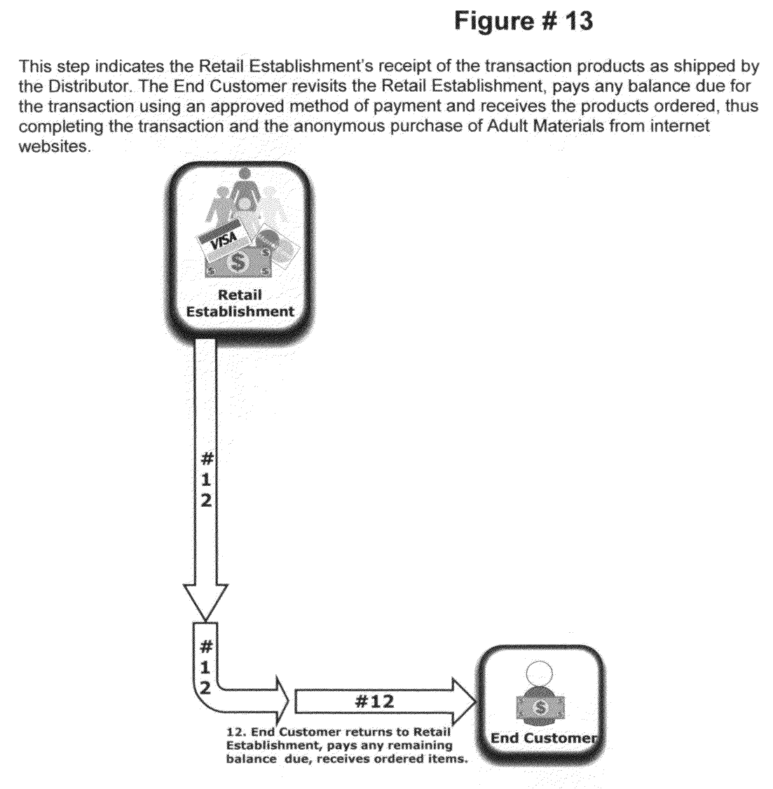

1. The need for a customer to have access to purchasing legal, adult sexually-orientated materials from an internet website, or multiple internet websites, with the ability of paying for and receiving those materials anonymously, as indicated by various process numbers listed on FIG. 1. Legal, adult sexually-orientated materials are defined, as referenced from the “Trademark Acceptable Identification of Goods & Services” web page of the United States Patent & Trademark Office website, as follows”

| Class | Description |
|---|---|
| 010 | Adult sexual stimulation aids, namely: artificial penises; penis |
| | enlargers; vibrators; benwa balls; artificial vaginas; any vibrating |
| | device used primarily for sexual stimulation; |
| | restraint devices such as handcuffs, ties, leather straps, ropes used |
| | primarily for sexual stimulation; |
| 010 | Adult sexual stimulation kit comprised primarily of the adult sexual |
| | stimulation aids listed in the previous paragraph combined |
| | with a workbook or other printed matter providing instruction |
| | or guidance in using the aids to provide sexual stimulation. |
| 009 | Pre-recorded DVDs featuring sexually-orientated materials that |
| | show male and/or female genitalia in a state of arousal |
| | while conducting sexual acts. |
| 009 | Digital media, namely, pre-recorded video cassettes, digital video |
| | discs, digital Versatile discs, DVDs, CDs, high definition digital |
| | discs (Blu-ray or other), or any not as of yet defined or named high |
| | definition digital disc or other physical means for the conveyance |
| | of digital files consisting of digital media featuring sexually- |
| | orientated materials that show male and/or female genitalia in a |
| | state of arousal while conducting sexual acts. |
| 005 | Non-medical personal lubricants, silicone-based personal lubricants, |
| | water-based personal lubricants primarily marketed for use while |
| | conducting sexual acts. |
| 005 | Herbal male and female enhancement capsules, topical liquids or |
| | gels designed and marketed primarily for enhancing the stimulation |
| | of male and female genitalia while conducting sexual acts. |
| 016 | Magazines, books, pamphlets or other printed matter featuring |
| | sexually-orientated materials that show male and/or |
| | female genitalia in a state of arousal while conducting sexual acts. |
| 025 | Lingerie and lingerie accessories designed to emphasize or draw |
| | extra attention to male or female genitalia, whether covered or |
| | visible, primarily used for stimulation prior to, or during sexual acts |

2. Executing an agreement between the website operator and the kiosk system provider/inventor allowing the kiosk system to access and allow purchasing of materials listed on claim #1 from the operator's website, as indicated by Process #1 on FIG. 1.

3. Executing an agreement between the website operator(s) and the retail establishment, that allows the retail establishment to act as either a reseller, or a commissioned independent representative for the website operator(s) who are providing materials listed in claim #1, as indicated by Process #4 on FIG. 1.

4. Executing an agreement between the kiosk system/inventor authorizing the placement of an ordering kiosk system located in a retail establishment providing purchasing ability of materials listed in claim #1, as indicated by Process # 3 and # 5 on FIG. 1.

5. Allowing an end customer to view and purchase products as listed in claim #1 from a designated or a number of designated websites via the World Wide Web as indicated by Processes #6, #7 and #8 listed on FIG. 1.

6. Providing the end customer anonymous purchasing capabilities of said materials in claim #1 and make payment at the retail establishment in any method of payment including cash, with the understanding that using cash or other non-private methods of payment will result in an anonymous transaction with no personal information related to the end customer captured as a part of the transaction, as indicated by Process #9 listed on FIG. 1.

7. Providing the option for the end customer to have the materials listed in claim #1 shipped from the website operator to the retail establishment and held at the establishment for end customer pickup, as indicated by Processes #11 and #12 listed on FIG. 1. End customer will not have to personally identify themselves provided customer has retained transaction receipts listing items purchased and payments made for said items, thus providing anonymity for the customer.
